(19) United States
(12) Patent Application Publication
(10) Pub. No.: US 2024/0210569 A1
(43) Pub. Date: Jun. 27, 2024

(54) SYSTEM AND METHOD FOR ESTIMATING THE MOVEMENT OR POSITION OF A MOVING OBJECT

(71) Applicant: IXBLUE, SAINT-GERMAIN-EN-LAYE (FR)

(72) Inventors: Jean-Baptiste LACAMBRE, SAINT-GERMAIN-EN-LAYE (FR); Timothy BARFORD, SAINT-GERMAIN-EN-LAYE (FR); Guirec MORVANT, SAINT-GERMAIN-EN-LAYE (FR)

(21) Appl. No.: 18/087,160

(22) Filed: Dec. 22, 2022

(51) Int. Cl. G01S 19/31; G01S 19/23

(52) U.S. Cl. CPC G01S 19/31; G01S 19/23

(57) ABSTRACT

Disclosed is a system for estimating a movement or position of a moving object, which includes: an inertial measurement unit configured to produce measurement values; a receiving unit configured to receive an electromagnetic signal from at least one satellite; a validation module for checking whether a parameter derived from the received electromagnetic signal meets a predetermined criterion; an integration module configured to determine an intermediate value based on at least one of the measurement values; and a computing module configured to compute a value representative of the movement or position based on the intermediate value and, if the parameter meets the predetermined criterion, on a phase of a carrier of the received electromagnetic signal. Also disclosed is a method for estimating the movement or position of a moving object.

### BACKGROUND OF THE INVENTION

### Field of the Invention

The invention relates to estimation of a movement or position of a moving object.

More precisely the invention relates to a system and a method for estimating the movement or position of a moving object. The invention is applicable for estimating heave, or surge, or sway, of a vessel.

### Description of the Related Art

The position or movement of a moving object can be estimated using an inertial measurement unit (IMU). Inertial measurement units are however known to accumulate errors in measurement and are therefore frequently combined with another system to increase accuracy.

In this respect, it has for instance been proposed in the article “Applying Time-Differenced Carrier Phase in Nondifferential GPS/IMU Tightly Coupled Navigation Systems to Improve the Positioning Performance”, by Y. Zhao, in IEEE Transactions on Vehicular Technology, vol. 66, no. 2, pp. 992-1003, Feb. 2017 to combine Time Differenced Carrier Phase (TDCP) measurements of a Global Positioning System (GPS) and IMU measurements using a Kalman filter.

### SUMMARY OF THE INVENTION

In this context, the invention provides a system for estimating a movement or position of a moving object, comprising an inertial measurement unit configured to produce measurement values; a receiving unit configured to receive an electromagnetic signal from at least one satellite; a validation module for checking whether a parameter derived from the received electromagnetic signal meets a predetermined criterion; an integration module configured to determine an intermediate value based on at least one of the measurement values; and a computing module configured to compute a value representative of said movement or position based on said intermediate value and, if (and only if) the parameter meets the predetermined criterion, on a phase of a carrier of the received electromagnetic signal.

Hence, the determination of the value representative of said movement or position takes the phase of the carrier of the received electromagnetic signal into account only when the reliability of this received electromagnetic signal is validated by checking that the parameter meets the criterion.

The validation module may for instance be configured to check whether the parameter meets the predetermined criterion using at least a checking value determined based on said measurement values. In this embodiment, values derived from the inertial measurement unit are used to check the reliability of the received electromagnetic signal.

For example, the validation module may be configured to compute the parameter based on the phase of the carrier of the received electromagnetic signal and a displacement estimation derived at least from said checking value.

In the embodiment described below, the checking value is the intermediate value.

According to a possible implementation, as described below, the computing module may be configured to compute an error and/or to compute the value representative of said movement or position based on a raw value derived from or equal to the intermediate value, and corrected using the computed error, wherein the error is based on the phase of the carrier of the received electromagnetic signal if (and only if) the parameter meets the predetermined criterion. The determination of the value representative of said movement or position can thus operate even when the received electromagnetic signal is not validated, i.e. without the correction just mentioned.

In this case, the computing module is for instance configured to compute the value representative of said movement as the combination, by addition or subtraction, of the raw value and the computed error.

In a possible embodiment, the error is a speed error and/or the raw value is a raw speed value.

The value representative of said movement or position may for instance be in practice a speed along a vertical axis. As a possible variation, the value representative of said movement or position may be a speed along a horizontal axis.

In some embodiments, the system may comprise a further integration module configured to integrate the value representative of said movement or position into a value representative of a position of the moving object. In the example described below, this value representative of a position of the moving object is a heave value; in other embodiments, the value representative of a position could be a sway value or a surge value, for instance. The moving object may be a boat or vessel, for example.

The receiving unit may receive various electromagnetic signals (e.g. at least 3 or 4 electromagnetic signals) from a corresponding number of distinct satellites (e.g. at least 3 or 4 satellites, respectively).

The validation module may perform the actions indicated above for each of these electromagnetic signals, in particular checking whether a respective parameter derived from each of these electromagnetic signals meets a criterion (which may be the same criterion as mentioned above or another criterion specifically used for the signal concerned).

The computing module may then compute the value representative of said movement or position based on the intermediate value and on the respective phases of carriers of (at least 3 or at least 4) electromagnetic signals for which the respective parameter meets the corresponding criterion.

Thus, the invention presented above may be applied to several electromagnetic signals in a given system. The invention is however used whenever one of these electromagnetic signals is processed as explained above.

The invention also provides a method for estimating a movement or position of a moving object, comprising the following steps:
obtaining measurement values from an inertial measurement unit;
receiving an electromagnetic signal from at least one satellite using a receiving unit;
checking whether a parameter derived from the received electromagnetic signal meets a predetermined criterion;
determining an intermediate value based on at least one of the measurement values;
computing a value representative of said movement or position based on said intermediate value and, if the parameter meets the predetermined criterion, on a phase of a carrier of the received electromagnetic signal.

In the embodiment described below, the step of checking whether the parameter meets the predetermined criterion includes using a checking value determined based on said measurement values.

The method may also include a step of computing an error based, if (and only if) the parameter meets the predetermined criterion, on the phase of the carrier of the received electromagnetic signal; then, the step of computing the value representative of said movement or position may include correcting a raw value derived from or equal to the intermediate value, using the computed error.

As noted above, when a plurality of electromagnetic signals received from a plurality of satellites are used, the error may be computed based on the respective phases of carriers of (at least 3 or at least 4) electromagnetic signals for which the respective parameter meets the corresponding criterion.

The method may also include a step of integrating the value representative of said movement or position into a value representative of a position of the moving object.

The following description with reference to the accompanying drawings will make it clear what the invention consists of and how it can be achieved. The invention is not limited to the embodiments illustrated in the drawings and/or mentioned below. Accordingly, it should be understood that, where features mentioned in the claims are followed by reference signs, such signs are included solely for the purpose of enhancing the intelligibility of the claims and are in no way limiting on the scope of the claims.

### BRIEF DESCRIPTION OF THE DRAWINGS

In the accompanying drawings:

FIG. 1 illustrates an exemplary position estimation system; and

FIG. 2 is a diagram showing the main steps of a method for estimating a movement or position of a moving object.

### DESCRIPTION OF THE PREFERRED EMBODIMENTS

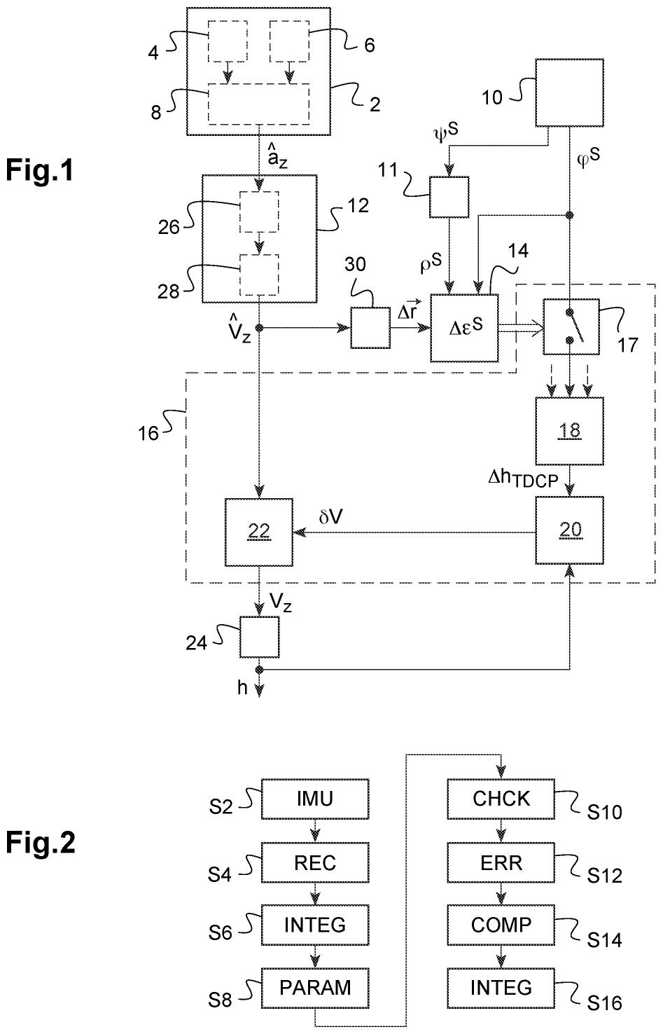

An exemplary system for estimating a movement and/or position of a moving object is shown in FIG. 1. This moving object is for instance a boat or vessel. The system is in this case an on-board system of the boat or vessel.

This system includes an inertial measurement unit 2, a receiving unit 10, a true range computation module 11, a first integration module 12, a validation module 14, a computing module 16 and a second integration module 24.

Each of these units and modules may be implemented either by a processor programmed by software instructions to perform the functions explained below for this unit or module, or by a programmable integrated circuit (such as an FPGA) programmed to perform these functions, or by an application specific integrated circuit (or ASIC) configured to perform these functions. In some embodiments, several units or modules may be implemented by the same processor or integrated circuit.

For instance, the inertial measurement unit 2 and the receiving unit 10 are each implemented by a dedicated processor or integrated circuit, while the first integration module 12, the validation module 14, the computing module 16 and the second integration module 24 are implemented by a processor executing computer program instructions designed so that the processor performs the functions described below for these modules when the computer program instructions are executed by the processor.

It may be noted in addition that several modules or units, including the inertial measurement unit 2, may be grouped into an Inertial Navigation System (INS).

The inertial measurement unit 2 comprises a plurality of sensors 4, 6, each located at a fixed position relative to the moving object. The sensors 4, 6 are for instance affixed to the moving object.

The sensors 4, 6 include for instance gyrometers 4 and/or accelerometers 6.

The inertial measurement unit 2 comprises a processing module 8 connected to the sensors 4, 6 so as to receive raw measurement signals from the sensors 4, 6. The processing module 8 is configured to produce measurement values based on the raw measurement signals. These measurements values include for instance angle variation values (which, after possible integration, may produce an estimation of an attitude of the moving object) and/or acceleration values representative of the instantaneous acceleration of the moving object, for instance 3 acceleration values respectively representative of the component along a given axis (among 3 axes) of the instantaneous acceleration of the moving object.

The processing module 8 produces in particular a vertical acceleration value â_{Z} representative of the instantaneous acceleration of the moving object along the vertical axis (this value being determined by the processing module 8 based on raw measurement signals received from the accelerometers 6). It may be noted that the vertical acceleration value â_{Z} is used here because it is sought in the present example to determine the heave of the moving object. In other embodiments where it is sought to determine the surge or the sway, a particular horizontal acceleration value will be considered instead.

The receiving unit 10 is a global positioning system, or global navigation satellite system (GNSS), configured to receive respective electromagnetic signals from a plurality of satellites, and to derive therefrom different values, some of which make it possible to determine the position of the receiving unit in a global frame of reference (although it is unnecessary to fully determine this position in the present embodiment).

For each satellite S in communication with the receiving unit 10 via electromagnetic signals, the receiving unit 10 is configured to produce in particular:
the instantaneous phase φ^{S} of the carrier used in the communication (in a particular frequency band) between the satellite S and the receiving unit 10;
the pseudo range ψ^{S} between the receiving unit 10 and the satellite S.

The true range computation module 11 is configured to compute the true range ρ^{S} (i.e. the distance) between the receiving unit 10 and the satellite S based on the pseudo range ψ^{S} produced by the receiving unit 10 (taking into account the receiver positions previously determined and ephemeris data).

The first integration module 12 is configured to determine an intermediate value (here a raw speed value \hat{V}_{Z}) based on at least one of the measurement values (here based on the vertical acceleration value â_{Z}) by integrating (over time) the concerned measurement value and, here, by applying a high-pass filter 28 to the integrated measurement value.

Use of a high-pass filter 28 makes it possible to select only the movement of interest and remove the long-term error drift caused by the integration of sensor errors. Thanks to the correction provided by the concurrent use of a Time-Difference-Carrier-Phase (TDCP) algorithm as explained below, the cut-off frequency of the high-pass filter 28 can be lowered: the cut-off frequency of the high-pass filter 28 is for instance below 8×10⁻³ Hz (corresponding to a cut-off period above 125 s, for instance a cut-off period of 150 s).

In practice, the first integration module 12 includes for instance an integration block 26 receiving the concerned measurement value as an input and producing the integrated measurement value as an output, and the high-pass filter 28 receiving the integrated measurement value as an input and producing the intermediate value (here the raw speed value \hat{V}_{Z}) as an output.

Although not shown in FIG. 1 for the sake of conciseness, the first integration module 12 receives in practice the 3 acceleration values (along 3 axes, respectively) mentioned above from the inertial measurement unit 2 and therefore produces 3 corresponding raw speed values (including the raw speed value \hat{V}_{Z}).

For each satellite S possibly used in the TDCP algorithm as explained below, the validation module 14 is configured to check whether a parameter derived from the electromagnetic signal received from this satellite meets a predetermined criterion so as to confirm whether values derived from this electromagnetic signal (included values obtained by the TDCP algorithm) may validly be used (in particular: to correct speed or position values determined based on measurement values provided by the inertial measurement unit, as explained below).

In the embodiment described here, it is proposed to check the consistency between the variation of the instantaneous phase φ^{S} of the carrier provided by the receiving unit 10 for a given satellite S, and the variation of the true range ρ^{S} which is estimated by the displacement of the moving object derived from measurement values provided by the inertial measurement unit 2.

Precisely, if we denote:
Δφ^{S} the carrier-phase offset difference at a time t relatively to a time t₀:

$${Δφ}^{S} = {φ}^{S} ( t ) - {φ}^{S} ( {t}_{0} )$$

the true range difference at time t relatively to time t₀:

$$Δ {ρ}^{S} = {ρ}^{S} ( t ) - {ρ}^{S} ( {t}_{0} )$$

we have:

$${λ}^{S} \cdot {Δφ}^{S} = Δ {ρ}^{S} + \vec{{e}^{S}} \cdot Δ \vec{r} + c \cdot ( t - {t}_{0} ) \cdot δ {t}_{dot} + Δ {ε}^{S}$$

where λ^{S} is the wavelength of the carrier, \vec{e^{S}} is a unitary vector pointing from the receiving unit 10 to the satellite S, here in the Earth-centered Earth-fixed (ECEF) frame of reference, Δ\vec{r} is the displacement of the receiving unit 10 (here in the ECEF frame of reference), c is the speed of light, δt_{dot} is the receiver clock bias drift between times t and t₀ (as a proportion of the time length between t and t₀) and Δε^{S} is the residual error (resulting e.g. from noise and multipath, and that should therefore normally be limited to small values amounting to a Gaussian noise).

The unitary vector \vec{e^{S}} can be estimated based on ephemeris data (providing the position of the satellite S) and an estimation of the position of the moving object (which needs not be very accurate and may be given for instance by a Global Positioning System).

As satellite clocks are very stable, their drift needs not be taken into account here.

As mentioned above, the displacement Δ\vec{r} is here determined on the basis of measurement values produced by the inertial measurement unit 2, for instance by integrating these measurement values. In the embodiment described, a short-term integrator 30 receives the raw speed values (produced by the first integration module 12) as inputs and produces components of the displacement Δ\vec{r} as outputs. According to possible variations, values derived from a Doppler Velocity Log (not shown) or the receiving unit 10 may be used together with the raw speed values to produce the displacement Δ\vec{r} (with less drift).

It is proposed here to use the residual error Δε^{S} for a given satellite S as the parameter that should meet a given criterion for the values derived from electromagnetic signals received from this given satellite S to be used in the computing module 16 described below (to correct speed or position values determined based on measurement values provided by the inertial measurement unit 2).

In order to determine the residual error Ass, the validation module 12 estimates the clock bias drift δt_{dot} by summing the equations as above for N distinct measurements coming from the various satellites available (N may be greater than the number of available satellites, as several measurements may be obtained from a given satellite, when several frequency bands are used for this satellite):

$${\sum }_{s = 1}^{N} {λ}^{s} \cdot {Δφ}^{s} = {\sum }_{s = 1}^{N} Δ {ρ}^{s} + {\sum }_{s = 1}^{N} \vec{{e}^{s}} \cdot Δ \vec{r} + N \cdot c \cdot ( t - {t}_{0} ) \cdot δ {t}_{dot}$$

considering that residual errors Δε^{S} from different measurements and/or satellites are negligible and/or partially compensate,
hence:

$$δ {t}_{dot} = \frac{1}{N \cdot c \cdot ( t - {t}_{0} )} {\sum }_{s = 1}^{N} ( {λ}^{s} \cdot {Δφ}^{s} - Δ {ρ}^{s} - \vec{{e}^{s}} \cdot Δ \vec{r} )$$

The validation module 14 then computes the residual error Δε^{S} for a given measurement from a satellite S (in practice for at least one measurement for each available satellite) as follows:

$$Δ {ε}^{S} = {λ}^{S} \cdot {Δφ}^{S} - Δ {ρ}^{S} - \vec{{e}^{S}} \cdot Δ \vec{r} - c \cdot ( t - {t}_{0} ) \cdot δ {t}_{a o t}$$

Although several measurements (corresponding to distinct frequency bands) may be used for each satellite to estimate the receiver clock bias drift δt_{dot} as explained above, only one measurement per satellite (corresponding to a particular electromagnetic signal in a given frequency band) is considered in the following (as the TDCP block 18 described below uses phases of carriers of electromagnetic signals received from distinct satellites). The validation module 12 is thus configured to compute the parameter (here the residual error Δε^{S}) based on the phase φ^{S} of the carrier of the electromagnetic signal received by the receiving unit 10 from satellite S and/or the true range ρ^{S} obtained from this electromagnetic signal by the receiving unit 10 and the true range computation block 11, and/or a displacement estimation Δ\vec{r} derived from at least a checking value determined based on measurement values (which are produced by the inertial measurement unit 2), this checking value being equal here to the intermediate value (raw speed value \hat{V}_{Z}).

As explained above, the validation module 14 is configured to check whether the parameter Δε^{S} meets a predetermined criterion, here whether the parameter Δε^{S} is below a threshold value.

This threshold value is for instance predetermined, i.e. determined when designing the system in a particular application. The threshold value may for instance be set to twice the standard deviation of residual errors Δε^{S} generally observed in the application concerned.

If the parameter Δε^{S} meets the criterion, i.e. here is below the threshold value, it is considered that values derived from the electromagnetic signal received from the concerned satellite S (in the concerned frequency band) are valid and some of these values will be used in the computing module 16 to determine the sought value representative of the position or movement of the moving object (here to correct the raw value representative of the position or movement and derived from measurement values produced by the inertial measurement unit 2), as explained below.

If the parameter Δε^{S} does not meet the criterion, i.e. here is above the threshold value, it is considered that values derived from the electromagnetic signal received from the concerned satellite S are not valid and will thus not be used in the computing module 16.

The validation module 14 makes a corresponding checking operation for an electromagnetic signal received (in a particular frequency band) from each available satellite.

As a possible variation, another solution may be used to determine whether the values derived from electromagnetic signals received from a given satellite are valid and may thus be used in the computing module 16. For instance, use can be made of pseudorange signals received from the satellite (instead of the carrier-phase), or of several signals received from the satellite.

The computing module 16 comprises a switching block 17, a TDCP block 18, a speed error computation block 20 and a speed error compensation block 22.

The switching block 17 is controlled by the validation module 14 in such a manner that, when the validation module 14 has determined that the parameter aΔε^{S} determined for a particular electromagnetic signal received (in a given frequency band) from a given satellite S meets the criterion, i.e. that an electromagnetic signal received from this satellite S in this frequency band may be validly used, the switching block 17 forwards the carrier phase value φ^{S} associated with this electromagnetic signal to the TDCP block 18.

The TDCP block 18 receives carrier phase values φ^{S} (respectively corresponding to successive operation times, or epochs, of the system and to electromagnetic signals from satellites S for which the parameter Δε^{S} meets the criterion) from the receiving unit 10 (via the switching block 17) and is configured to determine a heave variation Δh_{TDCP} (over a given period, for instance between two operation times or epochs) based on these carrier phase values φ^{S}.

As just noted, for a particular time or epoch, the TDCP block 18 receives carrier phase values φ^{S} of several electromagnetic signals received from distinct satellites, as shown in dotted lines in FIG. 1, and for which the validation module 14 has checked that the respective parameter Δε^{S} meets the criterion defined above. According to a possible variation, distinct criteria could be respectively used for the various electromagnetic signals; the criterion used for a given electromagnetic signal could depend on the frequency band of the given electromagnetic signal, for instance.

In this goal, the TDCP block 18 may use a solution as described in the article “A Precise Heave Determination System Using Time-Differenced GNSS Carrier Phase Measurements” by Cho MinGyou, Kang In-Suk, Park Chansik, in Journal of Positioning, Navigation, and Timing, vol. 6 Issue 4, pp. 149-157, 2017, for instance.

In this example, to produce the heave variation Δh_{TDCP}, the TDCP block 18 needs to receive 3 carrier phase values φ^{S} corresponding to electromagnetic signals respectively received from 3 distinct satellites which have been validated by validation module 14 (or 4 carrier phase values φ^{S} corresponding to electromagnetic signals respectively received from 4 distinct satellites if an estimation of time is concurrently needed). If less than the required number of electromagnetic signals are available and validated by the validation module 14, the speed error computation block 20 described below will produce a null value and there will thus be no error correction in the speed error compensation block 22. Thus, a speed value and/or position value may be produced even when electromagnetic signals are not available or validated.

When a sufficient number of electromagnetic signals are available and validated, the speed error computation block 20 receives the heave variation Δh_{TDCP} provided by the TDCP block 18 and determines a heave variation Δh_{IMU} (over the same period as the heave variation Δh_{TDCP}) based on the heave h produced by the second integration module 24 as explained below.

Based on these heave variation values Δh_{TDCP}, Δh_{IMU}, the speed error computation block 20 is configured to determine the equivalent speed error δV as follows:

$$δ V = \frac{Δ {h}_{T D C P} - Δ {h}_{IMU}}{T}$$

where T is the above-mentioned period over which heave variations Δh_{TDCP}, Δh_{IMU} are considered, i.e. here the difference between two successive times at which heave is estimated.

This equivalent speed error δV accounts for a displacement error (equal to Δh_{TDCP}−Δh_{IMU}) in the heave estimation obtained based on measurements from the inertial measurement unit 2 when considering that the heave estimation obtained by the TDCP block 18 is perfect and over the time length T between two estimation times.

For a given epoch (or operation time), the heave variation Δh_{IMU} cannot be based on the heave h produced during this epoch (as this information is not yet available), but on heave values h produced for 2 preceding epochs; the heave variation Δh_{TDCP} shall also be considered between these 2 preceding epochs and the speed error δV computed at the given epoch thus actually relates to a preceding epoch. This is however not prejudicial as the time between 2 epochs is generally short and the compensation described below will thus occur only with a slight delay.

The speed error compensation block 22 receives the intermediate value (here the raw speed value \hat{V}_{Z}) from the first integration module 12; in addition, the speed error compensation block 22 receives the error (here the speed error δV) from the speed error computation block 20.

The speed error compensation block 22 is then configured to determine the speed value V_{Z} based on the raw speed value \hat{V}_{Z} and on the speed error δV received from the speed error computation block and determined based on the phase of the carrier of the received electromagnetic signals for which the parameter Δε^{S} meets the criterion: the speed error compensation block 22 corrects the raw speed value \hat{V}_{Z} using the speed error δV, here by performing the following operation:

$${V}_{Z} = {\hat{V}}_{Z} - δ V .$$

It may be noted that, as the speed error is computed based on a heave variation Δh_{IMU} derived from a heave value h previously determined (e.g. determined in the preceding epoch or operating time) as explained above, the correction provided by taking into account the equivalent speed error is not instantaneous, but slightly delayed (e.g. delayed by an epoch). This is however not problematic as the time interval between two epochs is generally short (e.g. has a duration of 1 s).

The speed value V_{Z} produced by the computing module 16 (precisely, by the speed error compensation block 22, as just mentioned) is here applied to a second integration module 24 which provides at its output the sought value representative of the position of the moving object, here the heave h of the moving object, by integrating the speed value V_{Z} over time.

The second integration module 24 may include a high pass filter, which is applied in this case to integrated speed values and produces at its output the sought position (here heave h) of the moving object.

The same remarks and advantages as presented above for the first integration module also apply here. The cut-off frequency of the high-pass filter of the second integration module 24 can be lowered: this cut-off frequency is for instance below 8×10⁻³ Hz (corresponding to a cut-off period above 125 s, for instance a cut-off period of 150 s).

FIG. 2 shows the main steps of a method for estimating a position or a movement of a moving object.

In the present example, this method is performed by the system of FIG. 1.

The method includes a step S2 of obtaining measurement values from the inertial measurement unit 2.

The method also includes a step S4 of receiving an electromagnetic signal from at least one satellite using a receiving unit 10. Several electromagnetic signals may be received by the receiving unit 10 from several satellites, in some embodiments.

The method also includes a step S6 of determining an intermediate value based on at least one of the measurement values (here a value representative of vertical acceleration of the moving object), e.g. by integrating at least one of the measurement values.

The method further includes a step S8 of determining a parameter Δε^{S} derived from the received electromagnetic signal (e.g. by taking into account a phase of a carrier of the received electromagnetic signal) and using a checking value (possibly the intermediate value) derived from the measurement values.

When several electromagnetic signals are used, several such parameters may be determined in a similar manner.

The method then includes a step S10 of checking whether the parameter meets a predetermined criterion, i.e. in the present example whether this parameter Δε^{S} is below the above mentioned threshold value.

When several electromagnetic signals are used, the corresponding parameters determined in step S8 can be checked in this manner in step S10.

The method also includes a step S12 of computing an error δV (here a speed error) which is derived from the phase of the carrier of the received electromagnetic signal if (and only if) the parameter Δε^{S} derived from this electromagnetic signal meets the predetermined criterion. When several electromagnetic signals are used, the error δV is computed based on the respective carriers of received electromagnetic signals for which the corresponding parameter meets a corresponding criterion.

In the present example, this error δV is determined based on a position variation (here a heave variation) derived from previously determined position (here heave) values and/or, if (and only if) the parameter Δε^{S} derived from this electromagnetic signal meets the predetermined criterion, on a position variation (here a heave variation) determined based on the phase of the carrier of the received electromagnetic signal.

The method then includes a step S14 of computing a value V_{Z} representative of said movement or position based on said intermediate value \hat{V}_{Z} and on the computed error δV, and thus based in particular on the phase φ^{S} of a carrier of the received electromagnetic signal when the parameter Δε^{S} derived from this electromagnetic signal meets the predetermined criterion.

In the present example, the intermediate value V_{Z} is corrected by means of said error δV.

In the embodiment described here, the value V_{Z} representative of said movement or position is a value representative of movement, and the method further includes a step S16 of integrating this value V_{Z} representative of movement into the value h representative of a position (here heave) of the moving object.

The invention is not limited to the embodiments just described.

In particular, although the invention has been described in the case of heave estimation, it is also applicable to surge or sway estimation. In these applications, the acceleration and speed along a particular horizontal axis will be used instead of the acceleration and speed along the vertical axis, as already mentioned.

1. A system for estimating a movement or position of a moving object, comprising:
an inertial measurement unit configured to produce measurement values;
a receiving unit configured to receive an electromagnetic signal from at least one satellite;
a validation module for checking whether a parameter derived from the received electromagnetic signal meets a predetermined criterion;
an integration module configured to determine an intermediate value based on at least one of the measurement values;
a computing module configured to compute a value representative of said movement or position based on said intermediate value and, if the parameter meets the predetermined criterion, on a phase of a carrier of the received electromagnetic signal.

2. The system according to claim 1, wherein the validation module is configured to check whether the parameter meets the predetermined criterion using at least a checking value determined based on said measurement values.

3. The system according to claim 2, wherein the checking value is the intermediate value.

4. The system according to claim 2, wherein the validation module is configured to compute the parameter based on the phase of the carrier of the received electromagnetic signal and a displacement estimation derived at least from said checking value.

5. The system according to claim 4, wherein the checking value is the intermediate value.

6. The system according to claim 1, wherein the computing module is configured to compute an error and to compute the value representative of said movement or position based on a raw value derived from or equal to the intermediate value, and corrected using the computed error, wherein the error is based on the phase of the carrier of the received electromagnetic signal if the parameter meets the predetermined criterion.

7. The system of claim 6, wherein the error is a speed error and the raw value is a raw speed value.

8. The system according to claim 6, wherein the computing module is configured to compute the value representative of said movement as the combination, by addition or subtraction, of the raw value and the computed error.

9. The system of claim 8, wherein the error is a speed error and the raw value is a raw speed value.

10. The system according to claim 1, wherein the value representative of said movement or position is a speed along a vertical axis.

11. The system according to claim 1, comprising a further integration module configured to integrate the value representative of said movement or position into a value representative of a position of the moving object.

12. A method for estimating a movement or position of a moving object, comprising the following steps:
obtaining measurement values from an inertial measurement unit;
receiving an electromagnetic signal from at least one satellite using a receiving unit;
checking whether a parameter derived from the received electromagnetic signal meets a predetermined criterion;
determining an intermediate value based on at least one of the measurement values;
computing a value representative of said movement or position based on said intermediate value and, if the parameter meets the predetermined criterion, on a phase of a carrier of the received electromagnetic signal.

13. The method according to claim 12, wherein the step of checking whether the parameter meets the predetermined criterion includes using a checking value determined based on said measurement values.

14. The method according to claim 12, comprising a step of computing an error based, if the parameter meets the predetermined criterion, on the phase of the carrier of the received electromagnetic signal, wherein the step of computing the value representative of said movement or position includes correcting a raw value derived from or equal to the intermediate value, using the computed error.

15. The method according to claim 12, wherein the value representative of said movement or position is a speed along a vertical axis.

16. The method according to claim 12, comprising a step of integrating the value representative of said movement or position into a value representative of a position of the moving object.
